(19) United States
(12) Patent Application Publication
(10) Pub. No.: US 2020/0273356 A1
(43) Pub. Date: Aug. 27, 2020

(54) METHOD AND SYSTEM FOR AUTOMATICALLY UPDATING A CURRENT FLIGHT PLAN OF AN AIRCRAFT

(71) Applicant: Airbus Operations SAS, Toulouse (FR)

(72) Inventors: Sylvain RAYNAUD, Toulouse (FR); Esteban QUIROZ-HERNANDEZ, Toulouse (FR)

(21) Appl. No.: 16/793,514

(22) Filed: Feb. 18, 2020

(30) Foreign Application Priority Data
Feb. 21, 2019 (FR) 1901752

(51) Int. Cl. G08G 5/02; G08G 5/00; G05D 1/00; G01C 23/00

(52) U.S. Cl. CPC G08G 5/025; G08G 5/0039; G08G 5/0021; G01C 23/005; G08G 5/0013; G05D 1/0061; G08G 5/0078

(57) ABSTRACT

The system includes a module for monitoring whether a pilot controls the aircraft, a module for updating the flight plan based on a pilot-provided approach order, modules implemented if no pilot controls the aircraft, including a module for monitoring whether an approach order signal is sent by a ground control device, a module for verifying compatibility of the ground control device approach order, a module for updating the flight plan based on the approach order if there is safety compatibility, a module for updating the flight plan based on an approach order determined based on current data if no approach order is received by the aircraft or if the approach order received by the aircraft does not have safety compatibility. The system provides for updating the flight plan for a landing in good conditions, even without an approach order from the pilot or from the ground control device.

### CROSS-REFERENCES TO RELATED APPLICATIONS

This application claims the benefit of the French patent application No. 1901752 filed on Feb. 21, 2019, the entire disclosures of which are incorporated herein by way of reference.

### FIELD OF THE INVENTION

The present invention relates to a method and to a system for automatically updating a current flight plan of an aircraft.

### BACKGROUND OF THE INVENTION

In the context of an aircraft without a pilot or of an aircraft having reduced flight crew, the aircraft should be capable of updating its flight plan in order to achieve a landing in good conditions.

The choice of a runway and of an approach procedure is influenced by numerous factors. Some of these factors are specific to the aircraft, such as the radio navigation equipment on board the aircraft, in-flight faults, etc. Other factors are external to the aircraft, such as the weather, the medical services available in the event of a medical emergency, etc.

Nowadays, the approach procedure is chosen by the airline, air traffic control and the pilots.

In the flight preparation phase, the airline or the pilot chooses the destination airport and the diversion airports (or alternate airports) and establishes a flight plan for air traffic control ATC. The choice of the approach procedure in this phase is governed by commercial reasons and technical reasons.

During the flight, the pilot may retain the chosen destination airport and the chosen approach procedure. However, the flight crew may also change these choices depending on events that occur during the flight. The airline may also ask the pilot to change the destination airport. The pilot may also make a choice himself, for example in the event of a medical emergency, a technical fault with the aircraft or a change in weather. Air traffic control ATC may also ask the pilot to change the choice of the approach procedure, for example in the event of a runway closure or a very high volume of air traffic at the destination airport. The pilot must ensure at all times that the aircraft is capable of executing the chosen approach procedure in good conditions.

However, if the pilot is unable to perform piloting or if the aircraft is piloted without a pilot, it is still necessary to update the flight plan while ensuring that the updated flight plan allows the aircraft to execute an approach procedure in good conditions.

### SUMMARY OF THE INVENTION

An aim of the present invention is to mitigate these drawbacks by proposing a method and a system that make it possible to guarantee landing in good conditions.

To this end, the invention relates to a method for automatically updating a current flight plan of an aircraft.

According to the invention, the method comprises the following steps, implemented iteratively and automatically:
a first monitoring step, implemented by a first monitoring module, comprising monitoring whether or not a pilot is controlling the aircraft;
a first updating step, implemented by a first updating module if the first monitoring step determines that the pilot is controlling the aircraft, comprising updating the flight plan based on a first approach order provided by the pilot;
a series of steps implemented if the first monitoring step determines that the pilot is not controlling the aircraft, the series of steps comprising:
a second monitoring step, implemented by a second monitoring module, comprising monitoring whether or not at least one signal of a second approach order sent by a control device on the ground to the aircraft is received by the aircraft,
a first compatibility verification step, implemented by a first compatibility verification module, comprising verifying whether or not the second approach order sent by the control device on the ground has safety compatibility,
a second updating step, implemented by a second updating module if the second approach order is received by the aircraft and if the second approach order has safety compatibility, the second updating step comprising updating the flight plan based on the second approach order,
a third updating step, implemented by a third updating module if no approach order is received by the aircraft in response to an update request transmitted by a transmission module to the control device on the ground or if the second approach order received by the aircraft does not have safety compatibility, the third updating step comprising updating the flight plan based on a third approach order that is determined based on current data available on board the aircraft.

The method of the invention thus makes it possible to update the flight plan even if the pilot is unable to perform piloting. Priority over the control is given to the pilot, then to the control device on the ground and lastly to the method itself based on current data on board the aircraft, while at the same time ensuring that the update is compatible with safety.

According to one embodiment, the method comprises a second compatibility verification step before the first updating step, the second compatibility verification step being implemented by a second compatibility verification module and comprising verifying whether the first approach order provided by the pilot has safety compatibility,

the first updating step being implemented if the first approach order provided by the pilot furthermore has safety compatibility,

the method furthermore comprising a step of emitting an alert, implemented by an alert emission module if the first approach order provided by the pilot does not have safety compatibility, comprising emitting an alert indicating a compatibility problem.

The method additionally comprises a step of displaying approach order options, implemented by a display module, comprising displaying a list of approach order options in order to present the pilot with the approach option or options that he is able to provide.

The approach order from the pilot is thus also able to be monitored. If the method shows that the approach order does not allow a landing in good conditions, the method makes it possible to provide a list of approach orders that make it possible to perform a landing in good conditions.

The method furthermore comprises a step of ranking approach order options, implemented by a ranking module, comprising the following sub-steps:
a first filtering sub-step, implemented by a first filtering submodule, comprising disregarding the approach order option or options that do not satisfy at least one availability criterion,
a second filtering sub-step, implemented by a second filtering submodule, comprising disregarding the approach order option or options that do not satisfy at least one safety criterion,
a first grading sub-step, implemented by a first grading submodule, comprising assigning a grade to the approach order option or to each of the approach order options that were not disregarded in the first filtering sub-step and the second filtering sub-step, the grade being weighted for an approach order option the implementation of which by the aircraft has previously failed,
a ranking sub-step, implemented by a ranking submodule, comprising establishing the list of approach order options ranked according to the grade assigned to the approach order option or options in the first grading sub-step.

Advantageously, the second compatibility verification step comprises the following sub-steps:
a first ranking sub-step corresponding to the ranking step in which the approach order option corresponds to the first approach order,
a first compatibility determination sub-step, implemented by a first compatibility determination submodule, comprising determining whether the first approach order has safety compatibility, the first approach order having safety compatibility if the first approach order is not disregarded, the first approach order not having safety compatibility if the first approach order is disregarded.

According to one particular feature, the first compatibility verification step comprises the following sub-steps:
a second ranking sub-step corresponding to the ranking step in which the approach order option corresponds to the second approach order,
a second compatibility determination sub-step, implemented by a second compatibility determination submodule, comprising determining whether the second approach order has safety compatibility, the second approach order having safety compatibility if the second approach order is not disregarded, the second approach order not having safety compatibility if the second approach order is disregarded.

The method moreover comprises a storage step, implemented by a storage module, comprising storing a history of the approach order or of the approach orders, the history comprising at least the approach order or orders implemented by the aircraft.

The invention also relates to a system for automatically updating a current flight plan of an aircraft.

According to the invention, this system comprises:
a first updating module configured so as to update the flight plan based on a first approach order provided by the pilot if a pilot controlling the aircraft has been detected by a first monitoring module configured so as to monitor whether or not a pilot is controlling the aircraft;
a set of modules implemented if no pilot is controlling the aircraft, the set of modules comprising:
a second monitoring module configured so as to monitor whether or not at least one signal of a second approach order sent by a control device on the ground to the aircraft is received by the aircraft,
a first compatibility verification module configured so as to verify whether or not the second approach order sent by the control device on the ground has safety compatibility,
a second updating module configured so as to update the flight plan based on the second approach order if the second approach order is received by the aircraft and if the second approach order has safety compatibility,
a transmission module configured so as to transmit an update request to the control device on the ground,
a third updating module configured so as to update the flight plan based on a third approach order that is determined based on current data available on board the aircraft if no approach order is received by the aircraft in response to an update request transmitted by the transmission module to the control device on the ground or if the second approach order received by the aircraft does not have safety compatibility.

According to one embodiment, the system comprises:
a second compatibility verification module configured so as to verify whether the first approach order provided by the pilot has safety compatibility,
an alert emission module configured so as to emit an alert indicating a compatibility problem if the first approach order provided by the pilot does not have safety compatibility.

According to one particular feature, the system comprises a display module configured so as to display a list of approach order options in order to present the pilot with the approach option or options that he is able to provide.

According to another particular feature, the system comprises a ranking module, comprising the following submodules:
a first filtering submodule configured so as to disregard the approach order option or options that do not satisfy at least one availability criterion,
a second filtering submodule configured so as to disregard the approach order option or options that do not satisfy at least one safety criterion,
a first grading submodule configured so as to assign a grade to the approach order option or to each of the approach order options that were not disregarded by the first filtering submodule and the second filtering submodule, the grade being weighted for an approach order option, the implementation of which by the aircraft has previously failed,
a ranking submodule configured so as to establish the list of approach order options ranked according to the grade assigned to the approach order option or options by the first grading submodule.

The second compatibility verification module furthermore comprises a first compatibility determination submodule configured so as to determine whether the first approach order has safety compatibility and so as to be implemented after the ranking module in which the approach order option corresponds to the first approach order, the first approach order having safety compatibility if the first approach order is not disregarded, the first approach order not having safety compatibility if the first approach order is disregarded.

The first compatibility verification module moreover comprises a second compatibility determination submodule configured so as to determine whether the second approach order has safety compatibility and so as to be implemented after the ranking module in which the approach order option corresponds to the second approach order, the second approach order having safety compatibility if the second approach order is not disregarded, the second approach order not having safety compatibility if the second approach order is disregarded.

The system moreover additionally comprises a storage module configured so as to store a history of the approach order or of the approach orders, the history comprising at least the approach order or orders implemented by the aircraft.

The invention also relates to an aircraft including a system for automatically updating a current flight plan as specified above.

### BRIEF DESCRIPTION OF THE DRAWINGS

The invention, with its features and advantages, will become more clearly apparent upon reading the description provided with reference to the appended drawings, in which:

FIG. 1 shows a schematic view of one embodiment of the update system,

FIG. 2 shows an overview of one embodiment of the update method,

FIG. 3 shows an aircraft incorporating the update system.

### DETAILED DESCRIPTION OF THE PREFERRED EMBODIMENTS

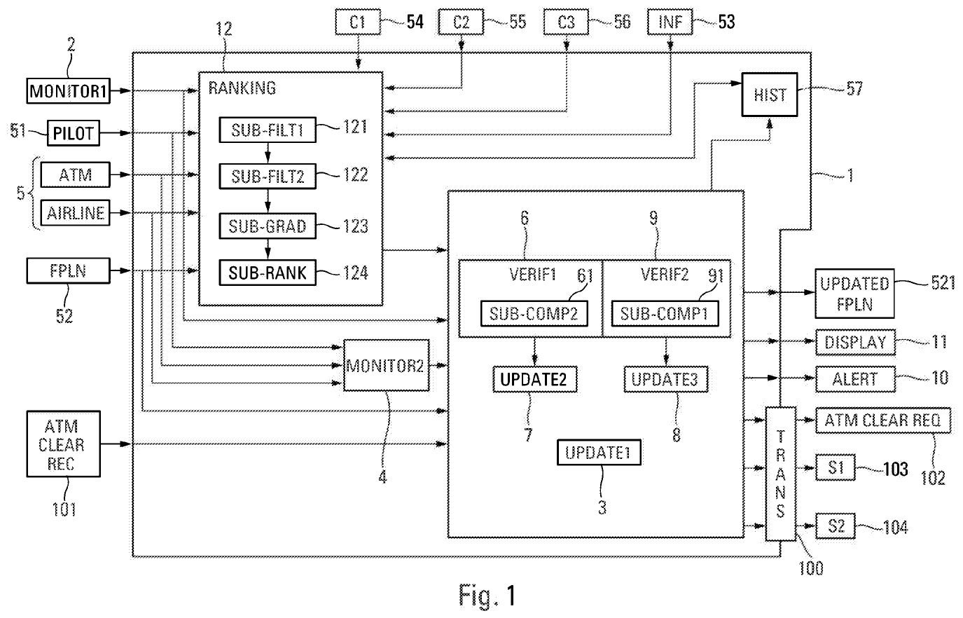

FIG. 1 schematically shows the system 1 for automatically updating a current flight plan FPLN (FPLN for flight plan) 52 of an aircraft AC, for example a transport plane. This system is called “update system” in the remainder of the description.

Before the flight, the update system 1, on board the aircraft AC (FIG. 3), may use at least one of the following sources of information:
a navigation database,
the flight plan 52, which comprises at least:
the destination airport and the approach procedure,
the diversion airport or airports and the associated approach procedure or procedures,
measurements of the amount of fuel on board the aircraft AC,
data regarding the airline's fuel reserve policy (for example, fuel reserve calculations),
a digitally coded notice to airmen NOTAM form,
weather forecast data,
a minimum equipment list MEL,
an up-to-date performance model of the aircraft AC.

During the flight, the update system 1 may use at least one of the following sources of information:
sources on board the aircraft AC:
faults with the navigation system of the aircraft AC,
the amount of fuel on board,
data regarding atmospheric conditions captured using sensors,
information from various sensors of the aircraft AC (for example, a sensor based on artificial vision for detecting obstacles on the runway);
sources of devices on the ground:
weather forecast updates, for example via the airline's operational communication system AOC (airline operational communication),
an automatic service for broadcasting information regarding airports D-ATIS (data automatic terminal information service),
coded instructions from the airline for updating the flight plan 52 and for updating the approach procedure,
coded instructions from air traffic control ATC for updating the flight plan 52, which may comprise part or all of the flight plan 52, and for updating the approach procedure.

The flight plan 52 may be stored in an on-board memory. For example, the flight plan is stored in a memory of a flight management system FMS. The updated flight plan UPDATED FPLN 521 updated by the update system 1 may also be stored in a memory of the FMS system.

The update system 1 may use several sources of information.

The update system 1 comprises an updating module UPDATE1 (UPDATE for updating module) 3. This updating module 3 is configured so as to update the flight plan 52 based on a first approach order provided by the pilot 51 of the aircraft AC, if a monitoring module MONITOR1 (MONITOR for monitoring module) 2 determines that a pilot 51 is controlling the aircraft AC. The pilot 51 may provide the first approach order using an input unit, such as a keypad or any other unit for providing an approach order.

The updating module 3 may also update the flight plan 52 on the condition that clearance ATM CLEAR REC (for ATM clearance reception) 101 is granted by an ATM (air traffic management) device after a clearance request ATM CLEAR REQ (for ATM clearance request) 102 has been sent by a transmission module TRANS (TRANS for transmission module) 100 contained in the update system 1.

An approach order corresponds to an approach procedure order for the purpose of landing on a runway.

An approach procedure defines a destination airport, a runway, waypoints for achieving the approach procedure, various types of sight-based or instrument-based primary approach means, a decision altitude and an interrupted approach trajectory.

The types of instrument-based primary approach means include the instrument landing system ILS, very high frequency omnidirectional radio range VOR, a satellite global positioning system GPS, etc.

The approach procedure is available in the form of a map in the navigation database of the computers on board the aircraft AC.

For greater clarity, in the remainder of the description, the expression “approach order” corresponds to the expression “approach procedure order” and the expression “approach” corresponds to the expression “approach procedure.”

According to one embodiment, the update system 1 comprises a compatibility verification module VERIF2 (VERIF for verification module) 9 configured so as to verify whether the first approach order provided by the pilot 51 has safety compatibility and an alert emission module ALERT (ALERT for alert module) 10. If the compatibility verification module 9 determines that the first approach order provided by the pilot 51 has safety compatibility, the updating module 3 updates the flight plan 52 based on a first approach order provided by the pilot 51 of the aircraft AC.

An approach order has safety compatibility if the approach resulting from the approach order allows the aircraft AC to approach for the purpose of landing on a runway in good conditions. Advantageously, the approach order meets at least availability criteria C1 54 of the runway and safety criteria C2 55 allowing the aircraft AC to land in good conditions. Protection against malicious attacks is also ensured, knowing that the approach order meets safety criteria 55.

The availability criterion or criteria and the safety criterion or criteria may be determined based on information from the sources of information listed above.

If the compatibility verification module 9 determines that the first approach order provided by the pilot 51 does not have safety compatibility, the alert emission module 10 emits an alert indicating a compatibility problem.

Advantageously, the update system 1 comprises a display module DISPLAY (DISPLAY for display module) 11 configured so as to display a list of approach order options in order to present the pilot 51 with the approach option or options that he is able to provide.

In one embodiment, if no approach order option is able to be presented, the display module 11 may present approach order options relating to a forced landing or to ditching.

The update system 1 may comprise a ranking module RANKING (RANKING for ranking module) 12. This ranking module 12 makes it possible to establish the list of approach order options that is presented to the pilot 51 by ranking them according to grades assigned to each of the approach order options.

In order to ensure that all of the available approach order options are taken into consideration, the ranking module 12 takes into account the possible approaches within a radius around the aircraft AC that is smaller than a predetermined radius. For example, the predetermined radius corresponds to a maximum distance able to be flown by the aircraft AC.

The ranking module 12 comprises:
a filtering submodule SUB_FILT1 (SUB_FILT for filtering submodule) 121 configured so as to disregard the approach order option or options that do not satisfy at least one availability criterion 54,
a filtering submodule SUB_FILT2 122 configured so as to disregard the approach order option or options that do not satisfy at least one safety criterion 55,
a grading submodule SUB_GRAD 123 configured so as to assign a grade to the approach order option or to each of the approach order options that were not disregarded by the filtering submodule 121 and the filtering submodule 122, the grade being weighted for an approach order option, the implementation of which by the aircraft AC has already previously failed,
a ranking submodule SUB_RANK (SUB_RANK for ranking submodule) 124 configured so as to establish the list of approach order options ranked according to the grade assigned to the approach order option or options by the first grading submodule 123.

The update system 1 may comprise a storage module HIST (HIST for history memory module) 57 configured so as to store a history of the approach order or of the approach orders. The history comprises at least the approach order or orders implemented by the aircraft AC. The history of the approach orders that have already been chosen may thus be stored in the storage module 57. The history may also comprise data fields associated with the approach orders that may make it possible to influence a subsequent grade. For example, the history comprises at least one approach order that failed and the reason or reasons for the failure of said order (weather, ATC instruction, etc.).

For the grading submodule 123, the approach option or options the implementation of which by the aircraft AC has failed may be found in this storage module 57. The weighting of the grade may correspond to reducing the grade for an approach order option, the implementation of which by the aircraft AC has previously failed.

Moreover, the transmission module 100 may transmit a signal S1 103 indicating the list of approach order options to the device on the ground 5.

If no approach order option satisfies the availability criterion or criteria 54 and the safety criteria 55, another ranking may be performed as a backup option.

According to one variant embodiment, if no approach order option satisfies the availability criterion or criteria 54 and the safety criteria 55, the update system 1 may choose an approach order corresponding to a forced landing or ditching.

The compatibility verification module 9 may comprise a compatibility determination submodule SUB_COMP1 (SUB_COMP for compatibility determination submodule) 91 configured so as to determine whether the first approach order has safety compatibility. The compatibility determination submodule 91 is implemented after the ranking module 12 in which the approach order option corresponds to the first approach order.

The first approach order has safety compatibility if the first approach order is not disregarded. The first approach order does not have safety compatibility if the first approach order is disregarded.

The update system 1 furthermore comprises a set of modules that are implemented if the monitoring module 2 determines that no pilot 51 is controlling the aircraft AC.

The set of modules comprises:
a monitoring module MONITOR2 4,
a compatibility verification module VERIF1 6
an updating module UPDATE2 7 and
an updating module UPDATE3 8.

The monitoring module 4 is configured so as to monitor whether or not at least one signal of a second approach order sent by a control device on the ground ATM/AIRLINE 5 to the aircraft AC is received by the aircraft AC.

The control device on the ground 5 may correspond to an air traffic management device ATM or a device designed to emit orders from an airline AIRLINE.

The compatibility verification module 6 is configured so as to verify whether or not the second approach order sent by the control device on the ground 5 has safety compatibility.

The updating module 7 is configured so as to update the flight plan 52 based on the second approach order:
if the monitoring module 4 has determined that the second approach order is received by the aircraft AC and
if the compatibility verification module 6 has determined that the second approach order has safety compatibility.

The updating module 7 may also update the flight plan 52 on the condition that clearance 101 is granted by the device ATM when the control device on the ground 5 corresponds to the device designed to emit orders from an airline AIRLINE.

The updating module 8 is configured so as to update the flight plan 52 based on a third approach order that is determined based on current data INF 53 available on board the aircraft AC:
if the monitoring module 4 has determined that no approach order is received by the aircraft AC in response to an update request transmitted by the transmission module 100 to the control device on the ground 5 or
if the compatibility verification module 6 has determined that the second approach order received by the aircraft AC does not have safety compatibility.

The updating module 8 may also update the flight plan 52 on the condition that clearance 101 is granted by the device ATM when the control device on the ground 5 corresponds to the device designed to emit orders from an airline.

The compatibility verification module 6 may comprise a compatibility determination submodule SUB_COMP2 61 configured so as to determine whether the second approach order has safety compatibility. The compatibility determination submodule 61 is implemented after the ranking module 12 in which the approach order option corresponds to the second approach order.

The second approach order has safety compatibility if the second approach order is not disregarded. The second approach order does not have safety compatibility if the second approach order is disregarded. Moreover, the transmission module 100 may transmit a signal S2 104 indicating whether or not the second approach order has been disregarded to the device on the ground 5.

In one embodiment, if a grade assigned to an approach order option is not zero, the update system 1 assigns a weighting coefficient to the approach orders from control devices on the ground 5 with respect to approach order options calculated on board the aircraft AC and based on an overall risk/performance analysis in order to choose the approach order option with the best ranking, even if this is not an approach order from the control device on the ground 5.

The availability criterion or criteria 54 comprise at least one of the following criteria:
the approach is coded in a navigation database NavDB,
no NOTAM notice indicates an unavailable runway or an unavailable approach,
no message from an automatic terminal information service ATIS indicates an unavailable runway or an unavailable approach,
the navigation and guidance systems are in an operative state,
no message from ATC indicates an unavailable runway or an unavailable approach.

Other availability criteria 54 may be used.

The navigation and guidance systems may correspond to an ILS system, to a synthetic vision system or to other landing assistance systems.

The safety criterion or criteria 55 comprise at least one of the following criteria:
a sufficient amount of fuel on board to achieve the approach,
weather conditions, such as wind speed or direction and visibility, lie within acceptable ranges,
no obstacle is detected on the runway,
the length of the runway is sufficient, taking into account elements that influence the braking efficiency of the aircraft AC.

Other safety criteria 55 may be used.

Whether the amount of fuel on board is sufficient may be defined based on the airline's fuel reserve policy.

Obstacles on the runway may be detected using on-board sensors on the aircraft AC.

Elements influencing the braking efficiency of the aircraft AC may comprise the landing mass, the intended braking action and the runway conditions (wet or dry runway, melted snow, etc.).

If none of the availability criteria 54 and safety criteria 55 are satisfied for an approach order option, the approach order option is then considered not to be viable. All of the approach order options that are considered not to be viable are not ranked and are disregarded. The grade assigned to these approach order options is zero.

The grading submodule 123 then assigns a grade to the approach order options that satisfy the availability criterion or criteria 54 and the safety criterion or criteria 55.

Advantageously, the grade assigned to an approach order option corresponds to a sum of estimates, each of the estimates being associated with a current criterion C3 56. Each of the estimates is equal to the product of a weighting coefficient and a numerical value.

For example, a weighting coefficient is defined for each current criterion 56 by the manufacturer of the aircraft AC or by the airline operating the aircraft AC. A numerical value is assigned for each current criterion 56 on the basis of the current or predicted conditions for a mission of the aircraft AC. The numerical value may correspond to a discrete variable, such as 0 or 1 for a current criterion 56 the verification of which is false or true. The numerical value may also correspond to a real variable, such as the predicted amount of reserve fuel.

Several current criteria 56 are listed below. The grade assigned to an approach order option may take into consideration at least one of these current criteria 56. The numerical value that may be assigned to the corresponding current criterion 56 is indicated between parentheses:
the destination airport corresponds to the intended destination airport in the initial flight plan filed by the airline (1 or 0),
the approach has been requested by the ATM device (1 or 0),
the approach has been requested by the airline (1 or 0),
the approach has been requested by the pilot 51 or automatically and has been authorized by the ATM device in the history of the mission (1 or 0),
the approach has been requested by the pilot 51 or automatically and has been denied by the ATM device in the history of the mission (1 or 0),
a go-around maneuver has been executed during the flight of the aircraft AC in the history of the mission because:
the runway was busy or an obstacle was detected (1 or 0),
the air traffic controller requested to change runway (1 or 0),
the ILS system or other air navigation aids were not used (1 or 0),
the air traffic controller requested a go-around (1 or 0),
a go-around maneuver was performed due to atmospheric conditions (wind shear, gusts, visibility) (1 or 0),
a go-around maneuver was performed due to inaccurate navigation (1 or 0),
the destination airport corresponds to the intended diversion airport in the initial flight plan (1 or 0),
the destination airport corresponds to an airport where the airline has staff on the ground (1 or 0),
the intended amount of fuel at landing (real variable),
the margin of the operational envelope linked to wind (real variable),
the margin for a predicted visibility depending on the approach minima (real variable),
the quality of the approach means, such as the decision altitude in feet, the reliability of the guidance means, the accuracy of the guidance means, the redundancy of the guidance means, etc. (real variable),
the length of the runway as a function of the landing distance based on information from the ATIS service,
the penalties due to noise at the approach airport (real variable),
the preference of the airline with regard to the destination associated with the approach (real variable),
the expected waiting time above the destination airport (real variable).

This list of current criteria 56 is not limiting. Other current criteria 56 may be used.

The update system 1 may comprise artificial intelligence that is trained in making a decision with regard to real air traffic over a large number of years.

The update system 1 may also deduce the availability and safety criteria and evaluate the options that are not nominal when the nominal options cannot be chosen.

In one embodiment, the update system 1 may also comprise a module for analyzing air traffic surrounding the aircraft AC in order to be able to confirm that the runway is in service and that it is available.

In another embodiment, the update system 1 may also comprise an automatic learning module implemented during standard flights in a monitoring mode.

In another embodiment, the update system 1 comprises a simulation analysis module (what if analysis) for ranking all of the potential events and for providing all of the strategies resulting from these events for preliminary validation by the pilot 51 or the control device on the ground 5.

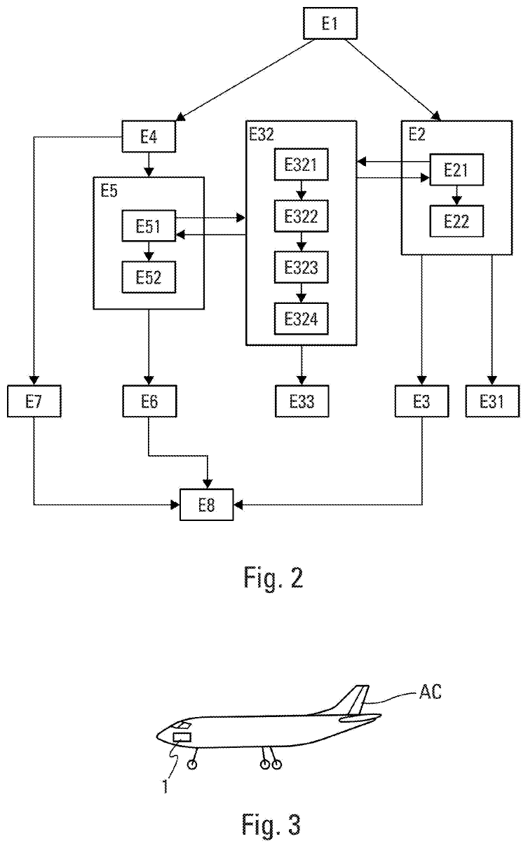

The invention also relates to a method for automatically updating a current flight plan 52 of an aircraft AC (FIG. 2).

The update method comprises the following steps, implemented iteratively and automatically in-flight:
a monitoring step E1, implemented by the monitoring module 2, comprising monitoring whether or not a pilot 51 is controlling the aircraft AC;
an updating step E3, implemented by the updating module 3 if the monitoring step E1 determines that the pilot 51 is controlling the aircraft AC, comprising updating the flight plan 52 based on a first approach order provided by the pilot 51;
a series of steps implemented if the monitoring step E1 determines that the pilot 51 is not controlling the aircraft AC, the series of steps comprising:
a monitoring step E4, implemented by the monitoring module 4, comprising monitoring whether or not at least one signal of a second approach order sent by the control device on the ground 5 to the aircraft AC is received by the aircraft AC,
a compatibility verification step E5, implemented by the compatibility verification module 6, comprising verifying whether or not the second approach order sent by the control device on the ground 5 has safety compatibility,
an updating step E6, implemented by the updating module 7 if the second approach order is received by the aircraft AC and if the second approach order has safety compatibility, the updating step E6 comprising updating the flight plan 52 based on the second approach order,
an updating step E7, implemented by the updating module 8 if no approach order is received by the aircraft AC in response to an update request transmitted by a transmission module 100 to the control device on the ground 5 or if the second approach order received by the aircraft AC does not have safety compatibility, the updating step E7 comprising updating the flight plan 52 based on a third approach order that is determined based on current data 53 available on board the aircraft AC.

The current data 53 available on board the aircraft AC may come from the sources of information listed at the beginning of the description. The current data 53 from these information sources are aggregated in order to establish an approach order for landing in good conditions.

According to one embodiment, the method comprises a compatibility verification step E2 before the updating step E3. The compatibility verification step E2 is implemented by the compatibility verification module 9 and comprises verifying whether the first approach order provided by the pilot 51 has safety compatibility. The updating step E3 is implemented by the updating module 3 if the first approach order provided by the pilot 51 furthermore has safety compatibility. The update method furthermore comprises a step E31 of emitting an alert, implemented by the alert emission module 10 if the first approach order provided by the pilot 51 does not have safety compatibility. The step E31 of emitting an alert comprises emitting an alert indicating a compatibility problem.

Advantageously, the update method comprises a step E33 of displaying approach order option suggestions, implemented by the display module 11, comprising displaying a list of approach order options in order to suggest the first approach order option from among the approach order options in said list to the pilot 51.

The update method may comprise a step E32 of ranking approach order options, implemented by the ranking module 12, comprising the following sub-steps:
a filtering sub-step E321, implemented by the filtering submodule 121, comprising disregarding the approach order option or options that do not satisfy at least one availability criterion 54,
a filtering sub-step E322, implemented by the filtering submodule 122, comprising disregarding the approach order option or options that do not satisfy at least one safety criterion 55,
a grading sub-step E323, implemented by the grading submodule 123, comprising assigning a grade to the approach order option or to each of the approach order options that were not disregarded in the filtering sub-step E321 and the filtering sub-step E322, the grade being weighted for an approach order option the implementation of which by the aircraft AC has already previously failed,
a ranking sub-step E324, implemented by the ranking submodule 124, comprising establishing the list of approach order options ranked according to the grade assigned to the approach order option or options in the grading sub-step E323.

The compatibility verification step E2 may comprise the following sub-steps:
a ranking sub-step E21 corresponding to the ranking step E32 in which the approach order option corresponds to the first approach order,
a compatibility determination sub-step E22, implemented by the compatibility determination submodule 91, comprising determining whether the first approach order has safety compatibility.

The compatibility verification step E5 comprises the following sub-steps:
a second ranking sub-step E51 corresponding to the ranking step E32 in which the approach order option corresponds to the second approach order,
a compatibility determination sub-step E52, implemented by the compatibility determination submodule 61, comprising determining whether the second approach order has safety compatibility.

The update method may furthermore comprise a storage step E8, implemented by the storage module 57, comprising storing the history of the approach order or of the approach orders, the history comprising at least the approach order or orders already implemented by the aircraft AC.

The update system 1 for determining the best approach order option therefore corresponds to a combination of a decision tree and heuristics.

The update system 1 thus makes it possible to choose a destination airport, an approach, an approach that has failed and a diversion destination airport. The information is updated during the flight until landing.

The update system 1 also makes it possible to evaluate a given fight plan 52 in order to determine the capability of the aircraft AC to achieve the flight plan 52. The evaluation is updated during the flight until landing.

The update system 1 may also be used to verify an approach order from the pilot 51 and to suggest approach order options to him as an aid.

When the aircraft AC is not being controlled by the pilot 51 or by the control device on the ground 5, the update system 1 takes into consideration current aggregated data 53 from sources of information available on board the aircraft AC, from instructions provided by a control device on the ground 5 and from clearance 101.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for automatically updating a current flight plan of an aircraft, comprising the following steps, implemented iteratively and automatically:
a first monitoring step, implemented by a first monitoring module, comprising monitoring whether or not a pilot is controlling the aircraft;
a first updating step, implemented by a first updating module if the first monitoring step determines that the pilot is controlling the aircraft, comprising updating the flight plan based on a first approach order provided by the pilot;
a series of steps implemented if the first monitoring step determines that the pilot is not controlling the aircraft, the series of steps comprising:
a second monitoring step, implemented by a second monitoring module, comprising monitoring whether or not at least one signal of a second approach order sent by a ground control device to the aircraft is received by the aircraft,
a first compatibility verification step, implemented by a first compatibility verification module, comprising verifying whether or not the second approach order sent by the ground control device has safety compatibility,
a second updating step, implemented by a second updating module if the second approach order is received by the aircraft and if the second approach order has safety compatibility, the second updating step comprising updating the flight plan based on the second approach order,
a third updating step, implemented by a third updating module if no approach order is received by the aircraft in response to an update request transmitted by a transmission module to the ground control device or if the second approach order received by the aircraft does not have safety compatibility, the third updating step comprising updating the flight plan based on a third approach order that is determined based on current data available on board the aircraft.

2. The method according to claim 1, further comprising:
a second compatibility verification step before the first updating step, the second compatibility verification step being implemented by a second compatibility verification module and comprising verifying whether the first approach order provided by the pilot has safety compatibility,
the first updating step being implemented if the first approach order provided by the pilot furthermore has safety compatibility,
the method furthermore comprising a step of emitting an alert, implemented by an alert emission module if the first approach order provided by the pilot does not have safety compatibility, comprising emitting the alert indicating a compatibility problem.

3. The method according to claim 1, further comprising a step of displaying approach order options, implemented by a display module, comprising displaying a list of approach order options in order to present the pilot with the approach option or options that he is able to provide.

4. The method according to claim 3, further comprising a step of ranking approach order options, implemented by a ranking module, comprising the following sub-steps:
a first filtering sub-step, implemented by a first filtering submodule, comprising disregarding the approach order option or options that do not satisfy at least one availability criterion,
a second filtering sub-step, implemented by a second filtering submodule, comprising disregarding the approach order option or options that do not satisfy at least one safety criterion,
a first grading sub-step, implemented by a first grading submodule, comprising assigning a grade to the approach order option or to each of the approach order options that were not disregarded in the first filtering sub-step and the second filtering sub-step, the grade being weighted for an approach order option, an implementation of which by the aircraft has previously failed,
a ranking sub-step, implemented by a ranking submodule, comprising establishing the list of approach order options ranked according to the grade assigned to the approach order option or options in the first grading sub-step.

5. The method according to claim 2, wherein the second compatibility verification step comprises the following sub-steps:
a first ranking sub-step corresponding to the ranking step in which the approach order option corresponds to the first approach order,
a first compatibility determination sub-step, implemented by a first compatibility determination submodule, comprising determining whether the first approach order has safety compatibility, the first approach order having safety compatibility if the first approach order is not disregarded, the first approach order not having safety compatibility if the first approach order is disregarded.

6. The method according to claim 1, wherein the first compatibility verification step comprises the following sub-steps:
a second ranking sub-step corresponding to the ranking step in which the approach order option corresponds to the second approach order,
a second compatibility determination sub-step, implemented by a second compatibility determination submodule, comprising determining whether the second approach order has safety compatibility, the second approach order having safety compatibility if the second approach order is not disregarded, the second approach order not having safety compatibility if the second approach order is disregarded.

7. The method according to claim 1, furthermore comprising a storage step, implemented by a storage module, comprising storing a history of the approach order or of the approach orders, the history comprising at least the approach order or orders implemented by the aircraft.

8. A system for automatically updating a current flight plan of an aircraft, comprising:
a first updating module configured to update the flight plan based on a first approach order provided by the pilot if the pilot controlling the aircraft has been detected by a first monitoring module configured so as to monitor whether or not the pilot is controlling the aircraft;
a set of modules implemented if no pilot is controlling the aircraft, the set of modules comprising:
a second monitoring module configured so as to monitor whether or not at least one signal of a second approach order sent by a ground control device to the aircraft is received by the aircraft,
a first compatibility verification module configured to verify whether or not the second approach order sent by the control device on the ground has safety compatibility,
a second updating module configured to update the flight plan based on the second approach order if the second approach order is received by the aircraft and if the second approach order has safety compatibility,
a transmission module configured to transmit an update request to the control device on the ground,
a third updating module configured to update the flight plan based on a third approach order that is determined based on current data available on board the aircraft if no approach order is received by the aircraft response to the update request transmitted by the transmission module to the control device on the ground or if the second approach order received by the aircraft does not have safety compatibility.

9. The system according to claim 8, comprising:
a second compatibility verification module configured to verify whether the first approach order provided by the pilot has safety compatibility,
an alert emission module configured to emit an alert indicating a compatibility problem if the first approach order provided by the pilot does not have safety compatibility.

10. The system according to claim 9, further comprising a display module configured to display a list of approach order options in order to present the pilot with the approach option or options that he is able to provide.

11. The system according to claim 10, further comprising a ranking module, comprising the following submodules:
a first filtering submodule configured to disregard the approach order option or options that do not satisfy at least one availability criterion,
a second filtering submodule configured to disregard the approach order option or options that do not satisfy at least one safety criterion,
a first grading submodule configured to assign a grade to the approach order option or to each of the approach order options that were not disregarded by the first filtering submodule and the second filtering submodule, the grade being weighted for an approach order option, an implementation of which by the aircraft has previously failed,
a ranking submodule configured to establish the list of approach order options ranked according to the grade assigned to the approach order option or options by the first grading submodule.

12. The system according to claim 9, wherein the second compatibility verification module comprises a first compatibility determination submodule configured to determine whether the first approach order has safety compatibility and to be implemented after the ranking module in which the approach order option corresponds to the first approach order, the first approach order having safety compatibility if the first approach order is not disregarded, the first approach order not having safety compatibility if the first approach order is disregarded.

13. The system according to claim 8, wherein the first compatibility verification module comprises a second compatibility determination submodule configured to determine whether the second approach order has safety compatibility and to be implemented after the ranking module in which the approach order option corresponds to the second approach order, the second approach order having safety compatibility if the second approach order is not disregarded, the second approach order not having safety compatibility if the second approach order is disregarded.

14. The system according to claim 8, furthermore comprising a storage module configured to store a history of the approach order or of the approach orders, the history comprising at least the approach order or orders implemented by the aircraft.

15. An aircraft, comprising a system for updating the current flight plan of the aircraft as specified in claim 8.
